(19) United States
(12) Patent Application Publication
(10) Pub. No.: US 2018/0247584 A1
(43) Pub. Date: Aug. 30, 2018

(54) MICRO LIGHT EMITTING DIODE ARRAY SUBSTRATES AND DISPLAY PANELS

(71) Applicant: Shenzhen China Star Optoelectronics Technology Co., Ltd., Shenzhen, Guangdong (CN)

(72) Inventor: Lixuan CHEN, Shenzhen, Guangdong (CN)

(73) Assignee: Shenzhen China Star Optoelectronics Technology Co., Ltd., Shenzhen, Guangdong (CN)

(21) Appl. No.: 15/515,235

(22) PCT Filed: Mar. 21, 2017
(86) PCT No.: PCT/CN2017/077464

§ 371 Date: Mar. 29, 2017

(30) Foreign Application Priority Data
Feb. 27, 2017 (CN) 201710106242.2

(51) Int. Cl. G09G 3/32; H05B 33/02; G02B 5/20; G09F 9/33; H01M 4/02

(52) U.S. Cl. CPC G09G 3/32; H05B 33/02; H01M 4/02; G09F 9/33; G02B 5/20

(57) ABSTRACT

The present disclosure relates to a Micro LED array substrate, including: a glass substrate, a gate and an insulation layer formed on the glass substrate in sequence, a semiconductor layer and at least one pixel electrode formed on the insulation layer, a source and a drain configured on the semiconductor layer, wherein the drain connects to the adjacent pixel electrode, and a first conductive layer covered on the pixel electrode, wherein the first conductive layer electrically connects to at least one Micro LED. The present disclosure further relates to a display panel, including a color filter (CF) substrate, wherein the CF substrate includes the Micro LED array substrate. In the view of the above, the heat of the Micro LED may transmit to other areas via a conductive layer by covering the conductive layer between the pixel electrode and the Micro LED, thereby to enhance heat dissipation capacity.

### BACKGROUND OF THE INVENTION

### 1. Field of the Invention

The present disclosure relates to micro light emitting diode (Micro LED) display field, more particular to a Micro LED array substrate and a display panel.

### 2. Discussion of the Related Art

Flat display device has been widely adopted in various kinds of consuming electronic products, such as mobile phones, personal digital assistants, digital cameras, laptops, desktop computers, and has become the main product among the display devices due to attributes such as high-definition, power-saving, thin body and wide application scope.

Micro light emitting diode (Micro LED, μLED) display adopts a high density and tiny-sized LED array integrated on a substrate to display images. Same as the large-size outdoor LED display, each of the pixels in the μLED can be addressed, illuminate alone, and can be viewed as a reduced version of the outdoor LED display, wherein the μLED reduces the pixel distance from millimeter to micrometer. μLED display is a self-luminous display, which is the same as organic light-emitting diode (OLED). However, μLED display is deemed as the greatest competitor of OLED due to attributes such as better stability, longer life cycle, and has no image imprinting.

Currently, the Micro LED array structure is designed on the top of the driving array. The thin-film transistor (TFT) array controls the switch and brightness of the Micro LEDs in each of the pixels via the electrical connection of the positive electrode and the negative electrode of the driving array. Driving the display unit via the TFT has become the main current-controlling technique. The TFT is controlled by the gate to form a current channel between the source and the drain, such that the storage capacitor of sub-pixel is charged to maintain the liquid crystal in a hold type display mode. Due to its micron scale, the density of the Micro LED may be too high when conducting high pixels per inch (PPI) display, which results in heat dissipation problems.

### SUMMARY

The present disclosure provides to a Micro LED array substrate and a display panel, thereby to enhance heat dissipation capacity.

In an aspect, a Micro LED array substrate, including: a glass substrate, a gate and an insulation layer formed on the glass substrate in sequence, a semiconductor layer and at least one pixel electrode formed on the insulation layer, a source and a drain configured on the semiconductor layer, wherein the drain connects to the adjacent pixel electrode, a first conductive layer covered on the pixel electrode, wherein the first conductive layer electrically connects to at least one Micro LED.

The first conductive layer is made of graphene material.

The first conductive layer is made of carbon nanotube (CNT) material.

A metal protrusion is configured between a pin of the Micro LED and the first conductive layer, and the pin of the Micro LED electrically connects to the first conductive layer via the metal protrusion.

A cross-section of the metal protrusion is in trapezoidal-shaped.

A graphene layer covers the metal protrusion.

A second conductive layer covers the source and the drain, and the second conductive layer electrically connects to a portion of the first conductive layer wherein the portion of the first conductive layer is arranged on the pixel electrode adjacent to the drain.

The second conductive layer is made of graphene material.

The first conductive layer covers the graphene material on the pixel electrode via a plasma enhancing vapor deposition process and the graphene material overlaps with a pattern of the pixel electrode to form a graphene film.

The present disclosure further provides a display panel, including a color filter (CF) substrate and the Micro LED array substrate.

In view of the above, the heat of the Micro LED may be transmitted to other areas via a conductive layer by covering the conductive layer between the pixel electrode and the Micro LED, thereby to enhance heat dissipation capacity.

### BRIEF DESCRIPTION OF THE DRAWINGS

FIG. 1 is a schematic view of a Micro LED array substrate in accordance with a first embodiment in the present disclosure.

FIG. 2 is a schematic view of a Micro LED array substrate in accordance with a second embodiment in the present disclosure.

### DETAILED DESCRIPTION OF THE EMBODIMENTS

Embodiments of the invention will now be described more fully hereinafter with reference to the accompanying drawings, in which embodiments of the invention are shown.

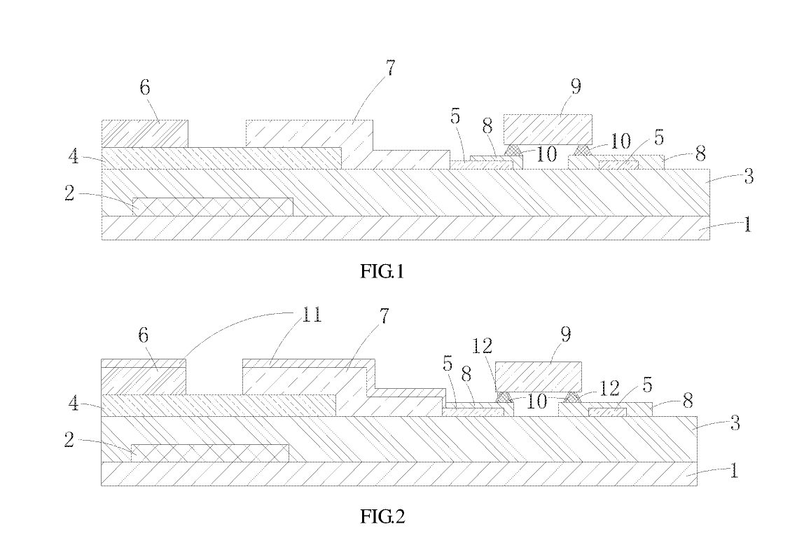

As shown in FIG. 1, in one embodiment, a Micro LED array substrate, including: a glass substrate 1, a gate 2 and an insulation layer 3 formed on the glass substrate 1 in sequence, a semiconductor layer 4 and at least one pixel electrode 5 formed on the insulation layer 3, a source 6 and a drain 7 configured on the semiconductor layer 4, wherein the drain 7 connects to the adjacent pixel electrode 5, and a first conductive layer 8 covered on the pixel electrode 5, wherein at least one Micro LED 9 is on the first conductive layer 8 and electrically connects to the first conductive layer 8. A metal protrusion 10 is configured between a pin of the Micro LED 9 and the first conductive layer 8, and the pin of the Micro LED 9 electrically connects to the first conductive layer 8 via the metal protrusion 10.

In one embodiment, the first conductive layer 8 is made of graphene material or carbon nanotube (CNT) material. Graphene not only has good electrical conductivity, but also has excellent thermal conductivity, and graphene can transfer heat from the Micro LED 9 with greater density and a local area with greater current density to ambient areas with lower temperature, such that to enhance overall heat dissipation capacity of the display panel.

The first conductive layer 8 covers the graphene material on the pixel electrode 5 via a plasma enhancing vapor deposition process and the graphene material overlaps with a pattern of the pixel electrode 5 to form a graphene film.

A graphene layer 12 may cover the metal protrusion 10, and a cross-section of the metal protrusion 10 may be in trapezoidal-shape.

As shown in FIG. 2, on the basis of the Micro LED described above, a second conductive layer 11 covers the source 6 and the drain 7, and the second conductive layer 11 electrically connects to a portion of the first conductive layer 8 wherein the portion of the first conductive layer 8 is arranged on the pixel electrode 5 adjacent to the drain 7. The second conductive layer 11 is made of graphene material. By covering the conductive layer on the source 6, the drain 7, and the pixel electrode 5, to enhance heat dissipation capacity.

In another aspect, covering the conductive layer on the source 6, the drain 7, and the pixel electrode 5 can not only enhance heat dissipation capacity, but protect the source 6, the drain 7, and the pixel electrode 5 from corrosion and oxidation by the surroundings, thereby to ensure device performance.

In the present disclosure, except the conductive layer arranged on the Micro LED, the remaining portion is similar to the conventional thin-film transistor (TFT) device. Wherein the source 6, the drain 7, the pixel electrode 5, and the gate 2 may adopt one or more of Al/Mo/Cu/Mg/Ag/Ti, and the pixel electrode 5 may further adopt indium tin oxide (ITO) semiconductor conductive film, Sn, and Sn alloy material. The semiconductor layer 4 may be amorphous silicon or polysilicon, and may superpose a n+/p+ doped layer on a metal layer that forms the source 6 and the drain 7.

The Micro LED array structure described above may be further configured to a TFT device of a top gate structure, which also connects the drain to the pixel electrode, thereby to control the current to passthrough the Micro LED.

In another aspect, a display panel, including a color filter (CF) substrate and the Micro LED array substrate described above, which may not be described repeatedly.

It is believed that the present disclosure is fully described by the embodiments, however, certain improvements and modifications may be made by those skilled in the art without departing from the principles of the present application, and such improvements and modifications shall be regarded as the scope of the present application.

What is claimed is:

1. A micro light emitting diode (Micro LED) array substrate, comprising:
a glass substrate;
a gate and an insulation layer formed on the glass substrate in sequence;
a semiconductor layer and at least one pixel electrode formed on the insulation layer;
a source and a drain configured on the semiconductor layer, wherein the drain connects to the adjacent pixel electrode;
a first conductive layer covered on the pixel electrode, wherein the first conductive layer electrically connects to at least one Micro LED.

2. The Micro LED array substrate according to claim 1, wherein the first conductive layer is made of graphene material.

3. The Micro LED array substrate according to claim 1, wherein the first conductive layer is made of carbon nanotube (CNT) material.

4. The Micro LED array substrate according to claim 1, wherein a metal protrusion is configured between a pin of the Micro LED and the first conductive layer, and the pin of the Micro LED electrically connects to the first conductive layer via the metal protrusion.

5. The Micro LED array substrate according to claim 4, wherein a cross-section of the metal protrusion is in trapezoidal-shaped.

6. The Micro LED array substrate according to claim 5, wherein a graphene layer covers the metal protrusion.

7. The Micro LED array substrate according to claim 1, wherein a second conductive layer covers the source and the drain, and the second conductive layer electrically connects to a portion of the first conductive layer wherein the portion of the first conductive layer is arranged on the pixel electrode adjacent to the drain.

8. The Micro LED array substrate according to claim 4, wherein a second conductive layer covers the source and the drain, and the second conductive layer electrically connects to a portion of the first conductive layer wherein the portion of the first conductive layer is arranged on the pixel electrode adjacent to the drain.

9. The Micro LED array substrate according to claim 7, wherein the second conductive layer is made of graphene material.

10. The Micro LED array substrate according to claim 2, wherein the first conductive layer covers the graphene material on the pixel electrode via a plasma enhancing vapor deposition process and the graphene material overlaps with a pattern of the pixel electrode to form a graphene film.

11. A display panel, comprising:
a color filter (CF) substrate, wherein the CF substrate comprises a Micro LED array substrate, and the Micro LED array substrate comprises:
a glass substrate;
a gate and an insulation layer formed on the glass substrate in sequence;
a semiconductor layer and at least one pixel electrode formed on the insulation layer;
a source and a drain configured on the semiconductor layer, wherein the drain connects to the adjacent pixel electrode;
a first conductive layer covered on the pixel electrode, wherein the first conductive layer connects to at least one Micro LED.

12. The display panel according to claim 11, wherein the first conductive layer is made of graphene material.

13. The display panel according to claim 11, wherein the first conductive layer is made of carbon nanotube (CNT) material.

14. The display panel according to claim 11, wherein a metal protrusion is configured between a pin of the Micro LED and the first conductive layer, and the pin of the Micro LED electrically connects to the first conductive layer via the metal protrusion.

15. The display panel according to claim 14, wherein a cross-section of the metal protrusion is in trapezoidal-shaped.

16. The display panel according to claim 15, wherein a graphene layer covers the metal protrusion.

17. The display panel according to claim 11, wherein a second conductive layer covers the source and the drain, and the second conductive layer electrically connects to a portion of the first conductive layer wherein the portion of the first conductive layer is arranged on the pixel electrode adjacent to the drain.

18. The display panel according to claim 14, wherein a second conductive layer covers the source and the drain, and the second conductive layer electrically connects to a portion of the first conductive layer wherein the portion of the first conductive layer is arranged on the pixel electrode adjacent to the drain.

19. The display panel according to claim 17, wherein the second conductive layer is made of graphene material.

20. The display panel according to claim 12, wherein the first conductive layer covers the graphene material on the pixel electrode via a plasma enhancing vapor deposition process and the graphene material overlaps with a pattern of the pixel electrode to form a graphene film.
